(19) United States
(12) Patent Application Publication
(10) Pub. No.: US 2024/0126338 A1
(43) Pub. Date: Apr. 18, 2024

(54) ELECTRONIC DEVICE WITH SLIDABLY DETACHABLE SCREEN

(71) Applicant: Gregory Andrew Sales, Elizabeth, NJ (US)

(72) Inventor: Gregory Andrew Sales, Elizabeth, NJ (US)

(21) Appl. No.: 18/530,378

(22) Filed: Dec. 6, 2023

Related U.S. Application Data
(63) Continuation-in-part of application No. 17/744,775, filed on May 16, 2022, now abandoned.

(51) Int. Cl. G06F 1/16

(52) U.S. Cl. CPC G06F 1/1654

(57) ABSTRACT

A removable screen is used on an electronic device such as a television. The screen is battery powered and has a wireless connection to the electronic device which enables the screen to show content even when not attached to the electronic device.

This application is a continuation-in-part of U.S. non-provisional application Ser. No. 17/744,775 filed on May 16, 2022, and which is incorporated herein in its entirety by reference.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

### Field of the Invention

The present invention relates to an electronic device with a screen. In particular, it relates to an electronic device with one or more detachable screens which remain connected wirelessly to the electronic device when the screen is removed.

### Description of Related Art

The use of electronic digital screens is ubiquitous over a wide range of products such as cell phones, computers, televisions, computers, watches, and the like. These devices either remain in place during use or need to remain in one place when charging. E.G., a television mounted on the wall or a phone in its charger. For devices like televisions, it becomes necessary to have multiple televisions to watch the television in different rooms. Many households have a large number of televisions in the bedroom, family room and living room. This solution for many is prohibitively expensive.

### BRIEF SUMMARY OF THE INVENTION

The present invention relates to solving the above problems with a detachable screen which when removed has its own internal power and can receive information from the device or be used in a different device. a charger in the electronic device charges the screen for use detached from the electronic device.

Accordingly, in one embodiment, there is an electronic device with a screen comprising:
a) wherein the screen is slidably detachable from the electronic device;
b) wherein the screen is battery operated and charges when attached to the electronic device; and
c) wherein the electronic device has a wireless digital connection to the screen when detached.

### BRIEF DESCRIPTION OF THE DRAWINGS

FIG. 1 is a frontal view of the electronic device and screen.

FIG. 2 is a frontal view of the detachable screen.

FIG. 3 is a frontal view of multiple screens.

### DETAILED DESCRIPTION OF THE INVENTION

While this invention is susceptible to embodiment in many different forms, there is shown in the drawings, and will herein be described in detail, specific embodiments with the understanding that the present disclosure of such embodiments is to be considered as an example of the principles and not intended to limit the invention to the specific embodiments shown and described. In the description below, like reference numerals are used to describe the same, similar, or corresponding parts in the several views of the drawings. This detailed description defines the meaning of the terms used herein and specifically describes embodiments in order for those skilled in the art to practice the invention.

### DEFINITIONS

The terms “about” and “essentially” mean±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to “one embodiment”, “certain embodiments”, “an embodiment”, or similar terms means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term “or”, as used herein, is to be interpreted as an inclusive or meaning any one or any combination. Therefore, “A, B, or C” means any of the following: “A; B; C; A and B; A and C; B and C; A, B, and C”. An exception to this definition will occur only when a combination of elements, functions, steps, or acts are in some way inherently mutually exclusive.

It is further noted that the claims may be drafted to exclude any element which may be optional. As such, this statement is intended to serve as antecedent basis for use of such exclusive terminology as “solely”, “only” and the like in connection with the recitation of claim elements, or the use of a “negative” limitation.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed. To the extent such publication may set out definitions of a term that conflict with the explicit or implicit definition of the present disclosure, the definition of the present disclosure controls.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

The drawings featured in the figures are for the purpose of illustrating certain convenient embodiments of the present invention and are not to be considered as limitation thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein, and use of the term “means” is not intended to be limiting.

As used herein, the term “electronic device with a screen” refers to a device used to view items on a digital screen such as, live pictures, videos, communications and the like. It includes cell phones, computers, watches, and the like. In one embodiment the electronic device is a television. The screen on these electronic devices is a digital type screen which displays pixels to form an image. The electronic device will have a device for keeping the rechargeable battery in the screen charged for use when it is removed from the electronic device.

As used herein the term “screen” refers to digital screens designed to view things associated or on the electronic device. They can be any relative size appropriate for use with the particular electronic device. For example, 65-inch televisions, 20-inch computer screens and the like. While the screen in one embodiment can be powered by AC current when it is detached, it has a rechargeable battery system. The rechargeable battery system in the screen is powered by a connection to the electronic device when it is placed for use on the electronic device in the attached condition. The screen will also have a wireless digital connection to the electronic device when the screen is in the detached condition. In that mode, one can take the screen to any room without having to bring the whole device which if the electronic device is heavy presents great difficulties. The screen is slidably mounted on the electronic device. In one embodiment it slides left or right from the electronic device. It automatically attaches to the power source and charger in the electronic device when it is attached.

As used herein, the term “slidably detachable” refers to the screen of the electronic device being removable by sliding to the right or left and disconnecting it from the electronic device. In one embodiment the connection is such that sliding the screen simultaneously disconnects the screen from the electronic device. It can be used alone to remotely watch the screen or it can be attached to a different compatible electronic device.

As used herein, the term “battery operated” refers to the screen when removed from the electronic device being powered by rechargeable batteries. The batteries recharge when docked in the electronic device by connection to a charger in the electronic device and allow the screen to be used remotely via the wireless connection to the electronic device.

As used herein, the term “charges” refers to the screen having its rechargeable

batteries recharged by connection to the electronic device.

As used herein, the term “wireless digital connection” refers to the screen being connected wirelessly in order to continue to play content provided by the electronic device.

As used herein, the term “multiple screens” refers to an option wherein one or more screens are positioned below the removable screen so that a user can keep watching on the electronic device and someone else can watch on the removable screen.

As used herein, the term “second electronic device” refers to a compatible device to the electronic device wherein the removable screen will attach to the second electronic device as well as the original electronic device.

### DRAWINGS

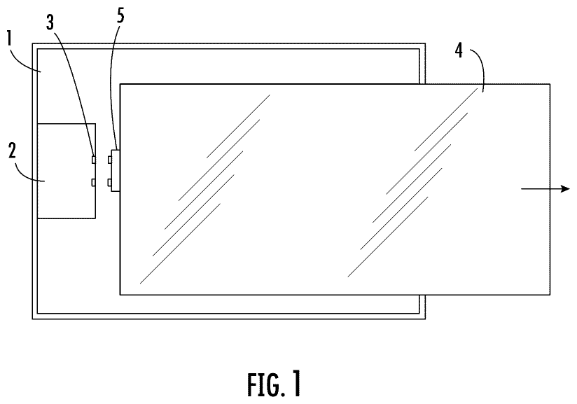

Now referring to the drawings. FIG. 1 is a front view of a television with the screen in the process of being removed. Television 1 has a charging module 2 with television connectors 3 for connecting the screen. Detachable screen 4 is shown in the process of detaching the screen by sliding it to the right and then off the electronic device 1. Screen connectors 5 are shown which connect to the television connectors when it is fully attached.

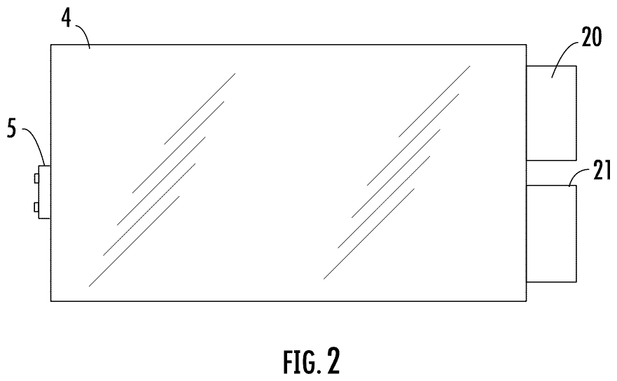

FIG. 2 is a front view of the screen 4 which is detached from television 1. In this view the rechargeable battery pack 20 is shown as well as a device for wireless connection 21 to the television.

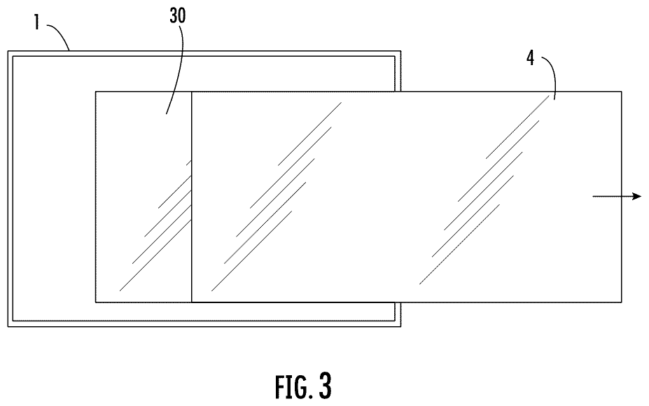

FIG. 3 shows a frontal view of an embodiment with multiple screens positioned on top of one another. That way someone can watch it on the device and someone else can watch it separately at the same time. Television 1 has screen 4 being removed to reveal a second screen 30. The second screen can be fixed or removable like screen 4.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials, and the like apparent to those skilled in the art still fall within the scope of the invention as claimed by the applicant.

What is claimed is:

1. An electronic device with a screen comprising:
a) wherein the screen is slidably detachable from the electronic device;
b) wherein the screen is battery operated and charges when attached to the electronic device; and
c) wherein the electronic device has a wireless digital connection to the screen when detached.

2. The electronic device according to claim 1 wherein the electronic device has multiple screens which fit into the electronic device at the same time.

3. The electronic device according to claim 1 wherein the electronic device is a television.

4. The electronic device according to claim 1 wherein the detached screen is attached to a second electronic device.
